(19) United States
(12) Patent Application Publication
(10) Pub. No.: US 2017/0326748 A1
(43) Pub. Date: Nov. 16, 2017

(54) A CHOPPER ASSEMBLY AND A METHOD FOR CUTTING A STRAND

(71) Applicant: Willem Frans VAN DER MAST, Eelde (NL)

(72) Inventor: Willem Frans VAN DER MAST, Eelde (NL)

(21) Appl. No.: 15/532,869

(22) PCT Filed: Dec. 1, 2015
(86) PCT No.: PCT/EP2015/078238

§ 371 Date: Jun. 2, 2017

(30) Foreign Application Priority Data
Dec. 4, 2014 (NL) 1041081

(51) Int. Cl. B26D 1/40; C03B 37/16; D01G 1/04; B26D 7/14; B26D 1/00

(52) U.S. Cl. CPC B26D 1/40; B26D 7/14; C03B 37/16; B26D 1/0006; D01G 1/04; B26D 2001/0053; B26D 2001/006

(57) ABSTRACT

A chopper assembly for cutting filaments in a strand into short lengths, comprising two rolls (1,4) being rotatable in opposite directions and having a pinch where the rolls (1,4) contact each other. At least one of the rolls (1,4) is provided with cutting blades (2,5) at its cylindrical outer surface. Means (15) are present for guiding said strand to said pinch where the filaments of the strand are cut. Both axes of rotation (16,17) of the rolls (1,4) are parallel to the tangential plane through said pinch and make an angle (α) with each other, so that the cutting blades (2,5) move in axial direction with respect to each other in the pinch.

The invention is related to a chopper assembly for cutting filaments in a strand into short lengths, comprising two rolls being rotatable in opposite directions and having a pinch where the rolls contact each other, wherein both axes of rotation of the rolls are parallel to the tangential plane through said pinch, and wherein means are present for guiding said strand to said pinch, and wherein at least one of the rolls is provided with cutting blades at its cylindrical outer surface.

The strand can be a bundle of glass or carbon filaments or any other material that has to be cut into short lengths, for example to be put in plastic material in order to improve the properties of that material. In this specification and in the claims, the term cutting is used for any action resulting in the separation of a filament into pieces, including bending the filament in order to break it. The cutting blades for cutting the filaments may be metal blades or may consist of any other suitable material. Furthermore, each roll can also be provided with other blades being not cutting blades, but blades for tensioning the strand by pushing the strand in zigzag shape between the rolls.

Publication WO02/055770 discloses such chopper assembly, whereby one of the rolls is provided with cutting blades. The other roll has recesses in axial direction in its cylindrical outer surface and, in the pinch, the outer edge of a cutting blade reaches into such recess and thereby cuts the bundle of filaments so that the filaments will break. A third roll is present in order to ensure a certain tension in the filaments entering the pinch.

The object of the invention is a chopper assembly for cutting filaments in a strand into short lengths, whereby an improved cutting action is applied.

In order to comply with that object, the two axes of rotation of said rolls make an angle with respect to each other. Thereby, in the pinch, the cutting blade mounted on a roll makes a movement in axial direction with respect to the other roll. Such movement of the cutting blade improves the cutting action, so that more types of strand in various conditions can be cut by means of the chopper assembly. In a preferred embodiment of the invention, said angle is more than 1 degree, more preferably more than 3 degrees, dependent on the material and the condition of the strand.

The roll without the cutting blades can have a cylindrical outer surface, without ribs, so that the cutting blades of the other roll make a cutting action in axial direction like a knife on that cylindrical surface, which surface is made of hard or elastic material.

In a preferred embodiment of the invention, both rolls are provided with a surface of elastic material at its cylindrical outer surface, wherein said surfaces contact each other in said pinch, and wherein the cutting blade reaches in an elongated recess in said surface of the other roll in said pinch. Thereby, the strand will be clammed between the surfaces of elastic material of both rolls and the filaments will break near the edge of the cutting blade, which cutting action is improved by the movement of the cutting blade in axial direction.

In a preferred embodiment of the invention, both rolls are provided with cutting blades at their cylindrical outer surfaces in such manner that each cutting blade of a roll meets a cutting blade of the other roll in the pinch, wherein the outer edges of the cutting blades of at least one of the rolls are inclined with respect to the axis of rotation of that roll, so that the outer edges of the cutting blades of both rolls in the pinch are parallel to each other. So, in the pinch, parallel edges of two cutting blades are near each other and moves in mutually opposite directions perpendicular with respect to said tangential plane through the pinch, and also moves in mutually opposite directions parallel to each other.

In a preferred embodiment of the invention, a rotatable stretching roll is present, having an axis of rotation parallel to the axis of rotation of one of the other rolls and having a pinch with that other roll where these rolls contact each other, wherein means are present for guiding the strand to that pinch. The stretching roll keeps the strand against the outer surface of one of the other rolls, so that the strand arrives correctly in the pinch of said other roll to be cut there. The cylindrical outer of the stretching roll may consist of elastic material or metal, and may have axially directed ribs and/or blades with a blunt outer edge.

In a preferred embodiment of the invention, the outer edges of at least a number of the cutting blades are sharp edges, so that the strand is bending in a sharp curve around the edge.

In a preferred embodiment of the invention, the outer edges of at least a number of the cutting blades are crenated edges. This means that the edge is rough, and is not a straight line in case of a sharp edge. Such edge can be obtained by a grinding or milling operation when machining the edge. Such edge is beneficial to the cutting action, because of the mutual axial movement of the cutting edges of the blades.

In a preferred embodiment of the invention, the distance between two cutting blades in de pinch is small, preferably smaller than 3 mm, more preferably smaller than 1.5 mm.

In a preferred embodiment of the invention one of the rolls is provided with a cylindrical outer surface consisting of elastic material, wherein said outer surface is provided with incisions made by the cutting blades, of the other cutting roll so, that the edge of each cutting blade inserts in the incision.

Furthermore, the invention is related to a method for cutting a strand into short lengths by means of a chopper assembly comprising two rolls being rotating in opposite directions and having a pinch where the rolls contact each other, wherein both axes of rotation of the rolls are parallel to the tangential plane through said pinch, and wherein the strand is guided to said pinch, and wherein at least one of the rolls is provided with cutting blades at its cylindrical outer surface, whereby, in said pinch, the cutting blades of a roll make a movement in axial direction of the other roll, depending on the angle between the axes of rotation of the rolls.

The invention will now be further elucidated by means of a description of an embodiment of a chopper assembly for cutting filaments in a strand into short lengths, whereby reference is made to the drawing comprising diagrammatical figures, showing schematically three rolls of the assembly, whereby:

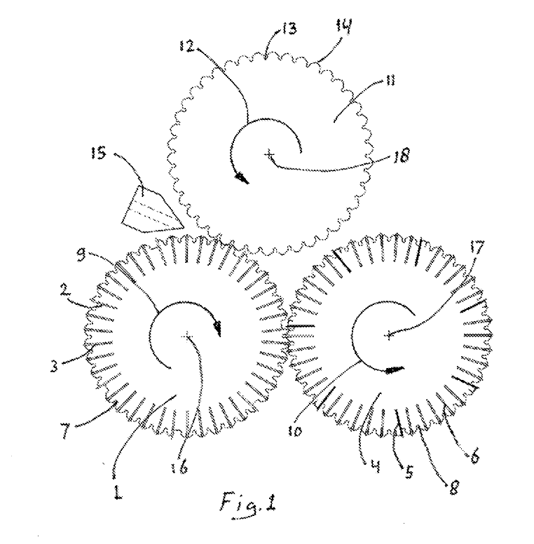

FIG. 1 shows three rolls in side view, and

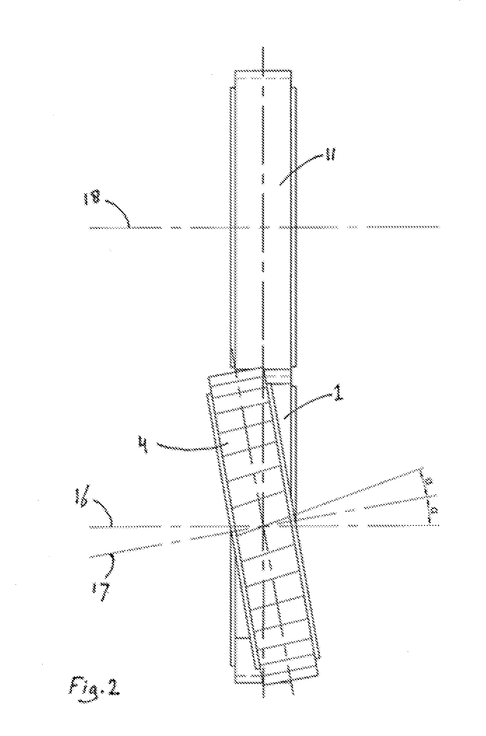

FIG. 2 shows these rolls from another position.

FIG. 1 is a schematic view of three rolls. Cutting roll 1 is provided with seven cutting blades 2 which are reproduced in black in the figure. Between each successive cutting blades 2 are five other blades 3. Cutting roll 4 is also provided with seven cutting blades 5 being reproduced in black in the figure. And between each successive cutting blades 5 are five other blades 6, just as is the case with cutting roll 1. The cutting blades 2,5 have sharp outer edges. The edge is a crenated edge, this means that the edge is rough, and is not a straight line. Such edge is obtained by a grinding operation when machining the sharp edge. The other blades 3,6 have blunt outer edges.

The material between the blades 2,3,5,6 of both cutting rolls 1,4 is elastic material and is provided with a recess 7, 8 between each pair of successive blades. The recesses 7,8 extend as a groove parallel to the blades 2,3,5,6, so that the cutting blades 2,5 and the other blades 3,6 can reach into the recesses 7,8 when they pass the pinch between cutting roll 1 and cutting roll 4. The cutting blades 5 of roll 4 are not positioned in the middle between the neighbouring other blades 6, so that these cutting blades 5 are close to the cutting blades 2 of roll 1 when they meet each other in the pinch between roll 1 and roll 4. In order allow that position of the cutting blades 2,5 in the pinch, the recess 7,8 at one side of each cutting blade 2,5 borders on that cutting blade 2,5. The rolls 1,4 are rotating in opposite directions, indicated with arrows 9,10.

A stretching roll 11 rotates in the direction indicated with arrow 12 and abuts cutting roll 1, forming a pinch. Stretching roll 11 is made of elastic material and has recesses 13 at its cylindrical outer surface, being grooves in axial direction. Between the recesses 13 are axial directed ribs 14. In the pinch between cutting roll 1 and stretching roll 11 reach the cutting blades 2 and the other blades 3 of roll 1 in the recesses 13 and the ribs 14 abut the elastic material between the blades 2,3 of cutting roll 1. The axes of rotation of the three rolls 1,4,11 are indicated with the numerals 16, 17 and 18 respectively.

In order to cut the filaments in a strand into short lengths, the strand (not shown in the figure) is guided by means of guiding member 15 to the pinch between cutting roll 1 and the stretching roll 11. In that pinch the strand is clammed between the ribs 14 of the stretching roll 11 and the elastic material between the blades 2,3 of cutting roll 1. Thereafter, the strand is guided by the radial outer surface of cutting roll 1 to the pinch between that cutting roll 1 and cutting roll 4. In that pinch, the filaments in the strand are cut because of the sharp bending between the cutting blades 2,5 of the two cutting rolls 1,4. And then short lengths of filaments are falling down, for example on a layer of plastic or another material into which the filaments have to be worked up.

FIG. 2 is another schematic view of the cutting rolls 1,4 and the stretching roll 11 of FIG. 1. Cutting roll 1 and stretching roll 11 have parallel rotational axes 16,18 and rotational axis 17 of cutting roll 4 makes an angle α with the rotational axis 16 of cutting roll 1. The blades 5,6 (indicated with straight lines in the figure) of cutting roll 4 makes the same angle α with the rotational axis 17 of cutting roll 4, in order to have the blades 5,6 parallel with respect to the blades of cutting roll 1 when they meet each other in the pinch between cutting roll 1 and cutting roll 4. The blades of cutting roll 1 are parallel to the rotational axis 16 of cutting roll 1. (These blades are not shown in schematic FIG. 2.)

While the invention has been illustrated in the figures and the foregoing description, the figures and description are to be considered as illustrative and exemplary and not as restrictive, the invention is not limited to the disclosed embodiments.

1. A chopper assembly for cutting filaments in a strand into short lengths, comprising two rolls being rotatable in opposite directions and having a pinch where the rolls contact each other, wherein both axes of rotation of the rolls (1,4) are parallel to the tangential plane through the pinch, and wherein means are present for guiding the strand to the pinch, and wherein at least one of the rolls is provided with cutting blades at its cylindrical outer surface, characterized in that the two axes of rotation of the rolls make an angle with each other.

2. The chopper assembly as described in claim 1, wherein the angle is more than 1 degree, preferably more than 3 degrees.

3. The chopper assembly as described in claim 1, wherein both rolls are provided with a surface of elastic material at its cylindrical outer surface, wherein the surfaces contact each other in the pinch, and wherein the cutting blade reaches in an elongated recess in the surface of the other roll in the pinch.

4. The chopper assembly as described in claim 1, wherein both rolls are provided with cutting blades at their cylindrical outer surfaces in such manner that each cutting blade of a roll meets a cutting blade of the other roll in the pinch, wherein the outer edges of the cutting blades of at least one of the rolls are inclined with respect to the axis of rotation of that roll, so that the outer edges of the cutting blades of both rolls in the pinch are parallel to each other.

5. The chopper assembly as described in claim 1, wherein a rotatable stretching roll is present, having an axis of rotation parallel to the axis of rotation of one of the other rolls and having a pinch with that other roll where these rolls contact each other and in that means are present for guiding the strand to that pinch.

6. The chopper assembly as described in claim 1, wherein the outer edges of at least a number of the cutting blades are sharp edges.

7. The chopper assembly as described in claim 1, wherein the outer edges of at least a number of the cutting blades are crenated edges.

8. The chopper assembly as described in claim 1, wherein the distance between two cutting blades in the pinch is less than 3 mm.

9. The chopper assembly as described in claim 1, wherein the distance between two cutting blades in the pinch is less than 1.5 mm.

10. The chopper assembly as described in claim 1, wherein one of the rolls is provided with a cylindrical outer surface consisting of elastic material, wherein the outer surface is provided with incisions made by the cutting blades of the other roll, so that the edge of each cutting blade of that other roll can insert in the incision.

11. A method for cutting a filaments in a strand into short lengths by means of a chopper assembly comprising two rolls being rotating in opposite directions and having a pinch where the rolls contact each other, wherein both axes of rotation of the rolls are parallel to the tangential plane through the pinch, and wherein the strand is guided to the pinch, and wherein at least one of the rolls is provided with cutting blades at its cylindrical outer surface, characterized in that, in the pinch, the cutting blades of a roll make a movement in axial direction of the other roll, depending on the angle between the axes of rotation of the rolls.
